(19) United States
(12) Patent Application Publication
(10) Pub. No.: US 2021/0116421 A1
(43) Pub. Date: Apr. 22, 2021

(54) Apparatus and Method for Ultrasonic Testing

(71) Applicant: Siemens Aktiengesellschaft, München (DE)

(72) Inventors: Johannes Vrana, München (DE); Matthias Goldammer, München (DE); Hubert Mooshofer, München (DE)

(73) Assignee: Siemens Aktiengesellschaft, München (DE)

(21) Appl. No.: 16/608,606

(22) PCT Filed: Apr. 25, 2018
(86) PCT No.: PCT/EP2018/060531

§ 371 Date: Oct. 25, 2019

(30) Foreign Application Priority Data
Apr. 28, 2017 (DE) 10 2017 207 269.5

(51) Int. Cl. G01N 29/34; G01N 29/11; G01N 29/24

(52) U.S. Cl. CPC G01N 29/343; G01N 29/11; G01N 2291/044; G01N 2291/015; G01N 29/2487

(57) ABSTRACT

Various embodiments include a method for ultrasonic testing using a selection of probes. In some embodiments, the method includes: ascertaining a set of shortest required respective latencies between two successive pulses for all possible firing sequences; calculating an optimized firing sequence of the shortest possible test cycle of the probes; and controlling the probes based on the optimized firing sequence to conduct an ultrasonic test.

### CROSS-REFERENCE TO RELATED APPLICATIONS

This application is a U.S. National Stage Application of International Application No. PCT/EP2018/060531 filed Apr. 25, 2018, which designates the United States of America, and claims priority to DE Application No. 10 2017 207 269.5 filed Apr. 28, 2017, the contents of which are hereby incorporated by reference in their entirety.

### TECHNICAL FIELD

The present disclosure relates to ultrasonic testing. Various embodiments may include methods and/or systems for conducting ultrasonic testing.

### BACKGROUND

In ultrasonic testing, a probe is placed on one side of the component and a short pulse is acoustically transmitted into said component. This pulse is reflected by discontinuities or defects and by the back wall. Following the reflection, reflected pulses propagate back to the probe which is employed as a receiver following the transmission of the short pulse, and hence said reflected pulses can be made visible. However, the reflected signals are likewise reflected back into the component again when striking the component surface and, as a result thereof, propagate a second, third, etc., time through the component. The probe records another signal after each ping-pong. Depending on the material, this signal is attenuated more and more, until it is drowned out by noise after a few ping-pong cycles.

Components are scanned during the ultrasonic test. There are many such pulses, which may likewise be referred to as shots, successively in time. Following the transmission of a further pulse, the received time signal may likewise contain late arrival reverberations from one of the earlier pulses, which have possibly not yet been attenuated enough, in particular multiply reflected reverberations, in addition to the actual signal. This would then lead to false indications or phantom echoes, which would be incorrectly interpreted as real defects. Therefore, there has to be a long enough wait between two pulses for the reverberations to have decayed sufficiently. The pulse repetition rate arises from this latency. Since the reverberations decay at different speeds in the case of a complex geometry of the test body, the pulse repetition rate must be set to the latest echoes in this case.

In the case of automated testing, a plurality of probes is sometimes used in parallel or one probe is sometimes used multiple times, for example with different gains for different depth ranges and the like. If a plurality of probes is used, a plurality of real channels is used by the test appliance; should one probe be used multiple times, reference is made to a plurality of virtual channels. However, each real or virtual channel can cause false indications in any other channel.

Phased array (PA) probes comprise a plurality of oscillators disposed in an array, which may be one dimensional or likewise be two dimensional. By way of late pulsing and receiving of the individual elements, the acoustic transmission angle can be electronically controlled, the focus of the sound beam can be electronically focused to a certain depth, the sound cone can be linearly displaced, etc. Each of these delay settings is referred to as “focal law”. However, often it is not a single angle that is driven during the phased array test; instead, the sound beam is pivoted. However, pivoting in this case means that the delay is set for a certain angle, the probe fires, the response is awaited and the delay is then set for the next angle, etc. Thus, the probe must pulse N-times in order to carry out an angle pivot with N different angles.

Accordingly, this applies likewise to a linear displacement or to a focus scan. Similar to the case of automated testing with various real or virtual channels, it is likewise possible for each pulse of the probe to cause a false indication in any other pulse here, however. Phased array probes can likewise be used during an automated test; in this respect, the pulse repetition rate may likewise be influenced by the aspects specified further above.

A phased array probe is used in full matrix capture (FMC) or the total focusing method (TFM). In these processes, it is usual for pulsing to be carried out by one element and reception to be carried out by all elements, upon which pulsing is carried out by the next element and all elements receive again, etc. The data obtained thus are then combined by calculation to form a result image. However, in this case, too, any pulse of the probe may cause a false indication of another pulse; in end effect, this may have a negative effect on the calculated result image.

In the synthetic aperture focusing technique (SAFT), the data of a plurality of probe positions, which may be provided in a conventional or in a phased-array configuration, and, possibly, the data from a plurality of real or virtual channels are combined with one another by calculation. Here, too, the conditions for avoiding false indications from late reverberations, as listed above, should be noted.

A suitable latency from one pulse to the next, i.e., the pulse repetition frequency, must be set prior to the test. Currently, this is carried out manually by the tester. This still is quite simple in the case of a test with one channel. To increase precision, starting from a very large value, the tester can continue to shorten the latency for as long as there just are no false indications arising in the A-image. Manual setting becomes an extremely time-consuming procedure in the case of a plurality of real and/or virtual channels, in the case of a plurality of focal laws or if use is made of FMC/TFM. However, latencies that have been set too long have an effect on the testing time. Therefore, attempts have to be made to optimize the latencies.

During the measurement, there often also is a change in the sound attenuation or reverberations may appear at different times or with different intensities as a result of the component geometry, and so false indications can once again be found at some positions in the result image. Then, the settings for the latencies have to be amended and the measurement can be started anew. In addition to optimizing the latencies, it is sometimes likewise expedient to interchange real and/or virtual channels or focal laws in order to further reduce the latencies. However, this leads to an even more time-consuming setting procedure in the case where the setting is done in manual fashion.

### SUMMARY

The teachings of the present disclosure may be used to automatically determine a shortest possible test cycle in the case of a combination of various measurement methods. By way of example, conventional probes may be combined with PA probes and/or FMCA PA probes. For example, some embodiments include a method for ultrasonic testing by means of a selection of probes, characterized in that a computer device is used to ascertain shortest required respective latencies between two successive pulses for all possible firing sequences (S1) and, subsequently, an optimized firing sequence (S2) of the shortest possible test cycle of the probes.

In some embodiments, the computer device is used to detect the combination of N pulses Pi with N reception settings EEi with i=1 . . . N.

In some embodiments, a time signal is recorded over a long time period for an N×N combinations matrix of pulses Pi and reception settings EEi with i=1 . . . N, said long time period containing all subsequent echoes with a relevant amplitude.

In some embodiments, a specification is defined for the maximum admissible amplitude of phantom echoes and set as reception setting EEi.

In some embodiments, the latencies following the pulses Pi and the minimum cycle duration are derived in each case from the matrix of N×N time signals and the amplitude specification for possible permutations of the pulses.

In some embodiments, the optimized or optimal pulse sequence is selected.

In some embodiments, an automatic determination of the length of the recording time period is carried out, with a decaying exponential function representing an envelope of the time signal being determined and a check being carried out as to whether the envelope at the end of the recording time period undershoots a certain value.

In some embodiments, the ascertained latencies following the pulses Pi are used directly for programming a test appliance or a test system.

In some embodiments, discrete optimization techniques are used in place of the full calculation for all channel permutations.

In some embodiments, a Monte Carlo approach is combined with the fully permutative approach.

In some embodiments, the time signals for each of the N×N combinations of pulse parameters and reception parameters are measured at a plurality of positions and the maximum of the time signals is subsequently determined over all positions.

In some embodiments, there is an automatic reevaluation of the shortest pulse sequence at regular intervals, in parallel with a test.

In some embodiments, instead of determining all time signals for every one of the N×N combinations of pulse and reception parameters, only some of the signals are determined by means of measurement, the remainder being replaced by prior knowledge.

In some embodiments, a plurality of reception settings are approximated by means of a single reception setting for an FMC test.

As another example, some embodiments include an apparatus for ultrasonic testing by means of one of the preceding methods, comprising a computer device for calculating shortest required latencies for all possible firing sequences and, subsequently, optimized firing sequences for a combination of at least one probe, at least one phased array probe and/or at least one FMC PA probe.

### BRIEF DESCRIPTION OF THE DRAWINGS

The teachings herein are described in more detail on the basis of exemplary embodiments in conjunction with the figures. In detail:

FIG. 1 shows a first exemplary embodiment of a representation of a pulse with subsequent reverberations;

FIG. 2 shows an exemplary embodiment of a combination of probes to be optimized;

FIG. 3 shows a representation of the procedure of ascertaining the optimum combination of probes;

FIG. 4 shows a representation of receiver settings EEi;

FIG. 5 shows a first representation of a second exemplary embodiment of a pulse with its reverberations;

FIG. 6 shows a second representation of the second exemplary embodiment of a pulse with its reverberations;

FIG. 7 shows a third representation of the second exemplary embodiment of a pulse with its reverberations;

FIG. 8 shows a fourth representation of the second exemplary embodiment of a pulse with its reverberations; and

FIG. 9 shows an exemplary embodiment of a method incorporating teachings of the present disclosure.

### DETAILED DESCRIPTION

In some embodiments, there is a method for ultrasonic testing by means of a selection of probes, wherein a computer device is used to ascertain shortest required respective latencies between two successive pulses for all possible firing sequences (S1) and, subsequently, an optimized firing sequence (S2) of the shortest possible test cycle of the probes.

In some embodiments, there is an apparatus for ultrasonic testing by means of one of the preceding methods, comprising a computer device for calculating shortest required latencies for all possible firing sequences and, subsequently, optimized firing sequences for a combination of at least one probe, at least one phased array probe and/or at least one FMC PA probe.

In some embodiments, initially determine the shortest required latencies T_{W}k for each possible firing sequence Pi with i=1 . . . N and to subsequently ascertain an optimum firing sequence.

In some embodiments, the computer device can be used to detect the combinations of N pulses Pi with N reception settings EEi with i=1 . . . N.

In some embodiments, a time signal can be recorded over a long time period for an N×N combinations matrix of pulses Pi and reception settings EEi with i=1 . . . N, said long time period containing all subsequent echoes with a relevant amplitude.

In some embodiments, a specification can be defined for the maximum admissible amplitude of phantom echoes and set as reception setting EEi.

In some embodiments, the latencies following the pulses Pi and the minimum cycle duration can be derived in each case from the matrix of N×N time signals and the amplitude specification for possible permutations of the pulses.

In some embodiments, the optimized or optimal pulse sequence can be selected.

In some embodiments, an automatic determination of the length of the recording time period can be carried out, with a decaying exponential function representing an envelope of the time signal being determined and a check being carried out as to whether the envelope at the end of the recording time period undershoots a certain value.

In some embodiments, the ascertained latencies following the pulses Pi can be used directly for programming a test appliance or a test system.

In some embodiments, discrete optimization techniques can be used in place of the full calculation for all channel permutations.

In some embodiments, a Monte Carlo approach can be combined with the fully permutative approach.

In some embodiments, the time signals for each of the N×N combinations of pulse parameters and reception parameters can be measured at a plurality of positions and the maximum of the time signals can be subsequently determined over all positions.

In some embodiments, there can be an automatic reevaluation of the shortest pulse sequence at regular intervals, in parallel with a test.

In some embodiments, instead of determining all time signals for every one of the N×N combinations of pulse and reception parameters, only some of the signals need be determined by means of measurement, the remainder being able to be replaced by prior knowledge.

In some embodiments, a plurality of reception settings can be approximated by means of a single reception setting for an FMC test.

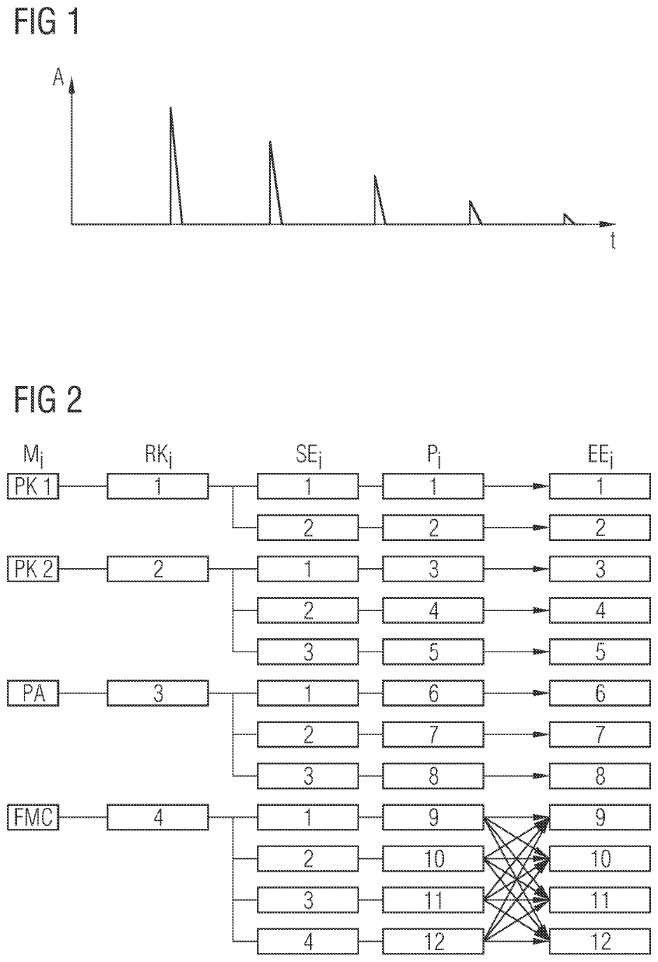

FIG. 1 shows a first exemplary embodiment of a representation of a pulse with subsequent reverberations. FIG. 2 shows an exemplary embodiment of a combination of probes to be optimized. Here, two conventional probes, one PA probe and one FMC PA probe are used during testing, in particular automated testing. The two conventional probes 1 and 2 are connected to the real channels 1 and 2, the PA probe is connected to channel 3 and the FMC PA probe is connected to channel 4. Probe 1 is pulsed with two different settings, to be precise by means of a virtual channel 1 and a virtual channel 2. Probe 2 is pulsed with three different settings, to be precise by means of the virtual channels 1, 2 and 3; the PA probe is pulsed with three different focal laws or delay settings, to be precise by means of three different angles, for example; and the FMC PA probe has four elements, with each element being pulsed individually and reception subsequently being carried out by all four elements. Thus, 12 pulses are fired in one cycle in this example. The aim for this situation is to automatically optimize the latencies and the sequence. To this end, it is necessary to ascertain the interaction of the N pulses with the N reception settings.

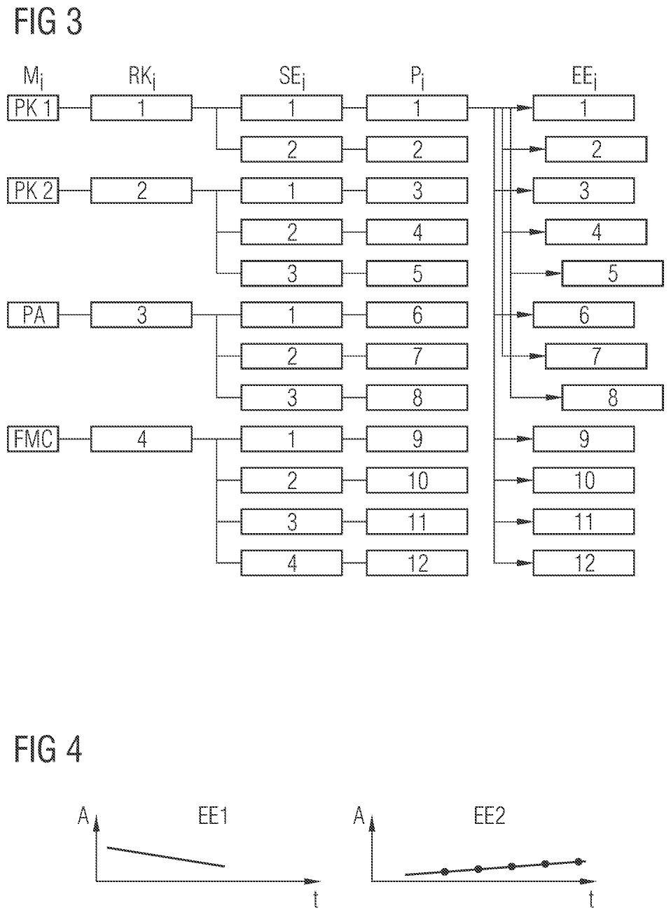

FIG. 3 shows a representation of the procedure of ascertaining the optimum combination of probes. In a first step S1, the pulse P1 can be started to this end and can be received and recorded by all N, 12 in this example, different reception settings EEi i=1 . . . N, i.e., all virtual channels that correspond to the conventional probes, all delay settings, to be precise of the PA probes, and all elements FMC PA. However, since each conventional probe or PA probe is only able to receive on one virtual channel or only able to receive and record with one delay setting, multiple pulses are needed for a full evaluation of the pulse in order to successively test all virtual channels. In the present example, pulsing must be carried out at least 3 times in the case of pulse 1, to be precise, indicated black, red and blue in FIG. 2.

The evaluation of certain receiver settings can be dispensed with depending on the setting of the receiver, for example if two receiver settings correspond. However, prior knowledge about the receiver settings must be available to this end. Should a different setting of the receiving elements be used in FMC depending on the transmitting element, the receiver settings EEi must likewise be tested in succession in this case.

FIG. 3 indicates that this process is subsequently repeated for pulse P2 to PN, respectively, where N=12 in this example. Hence, the full information about the interaction of all N pulses with all N reception settings is available. A time signal indicating the interaction is available for each of the N×N combinations.

Each receiver setting EEi is a certain gain that, in particular, may have a time dependence, and each receiver setting is associated with one or more time windows in which data are recorded. These time windows each have a start corresponding to the time in accordance with the transmitting pulse and a length allowing discontinuities or defects to be found therein. Moreover, signals are only meaningful above a certain signal level since the signals are otherwise lost in noise. Therefore, a signal level above which signals have to be evaluated must likewise always be set. The signal level together with the time window or the time windows results in one or more “blocks” per receiver setting, said blocks being constant or variable in time. No other pulse may be started within these “blocks”.

FIG. 4 shows two such “blocks”. For the further examples, use is made of the decreasing “block” for receiver setting EE1; the increasing block is used for receiver setting EE2. The block specifies the just still admissible level of the disturbing reverberations and echoes lying therebelow can be accepted.

FIG. 5 shows the time curve of a pulse Pi, which has been recorded by the receiver setting EE2, for example.

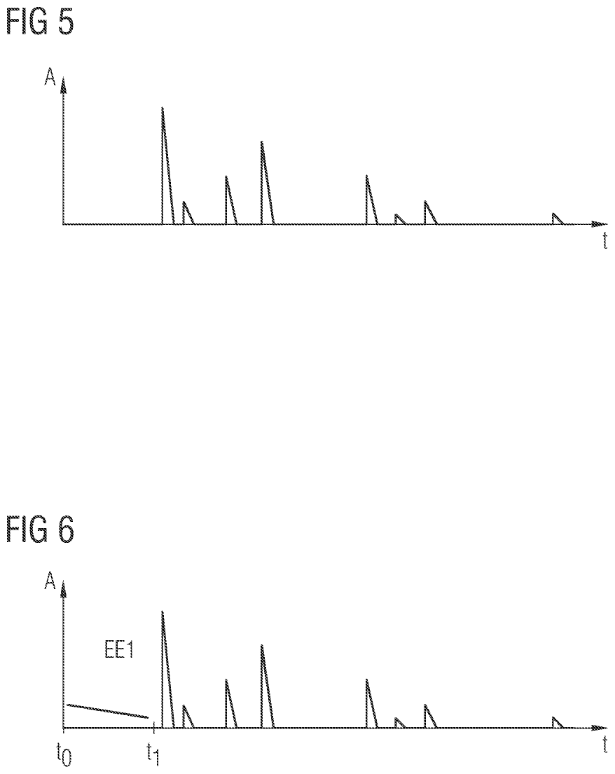

The time window marked in FIG. 6 by means of the straight line to t₁ represents the block of the receiver setting EE1 and not the block of the receiver setting EE2. Thus, no further pulse may be started within this time window from t₀ to t₁. A further pulse can be started following the time window, to be precise after t₁.

As already described above, a “block” or a time range t₀ₖ to t₁ₖ can be associated with each of the N receiver settings. Therefore, there now needs to be an evaluation in respect of the earliest regions in which a respective receiver setting is suitable. Here, the region should be long enough for the time window of the receiver setting to fit therein and observe admissible signal levels, more particularly time-dependent signal levels. The earlier the next pulse can be started, the shorter the overall pulse sequence will be.

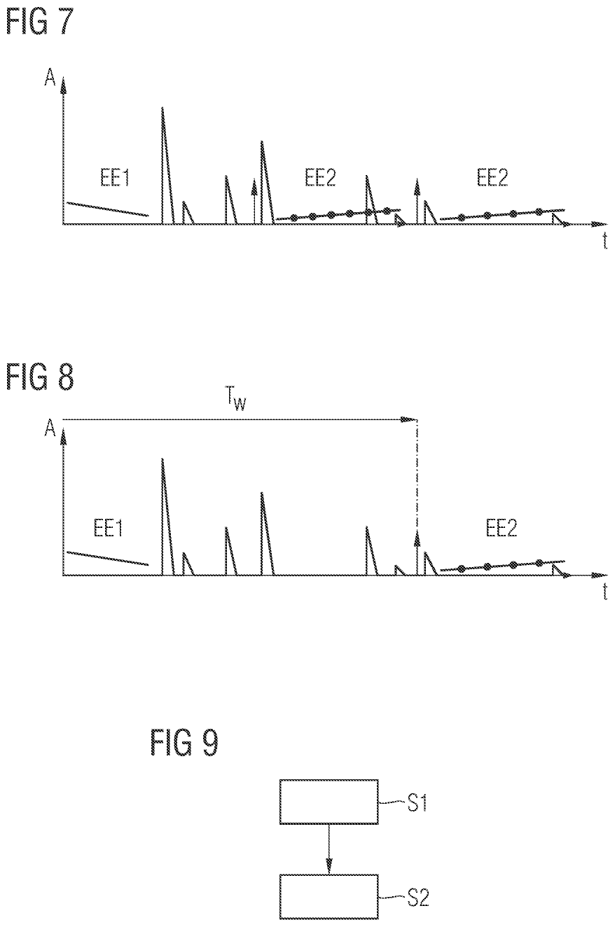

As an example, FIG. 7 shows that a receiver setting EE2 or “block” EE2 does not fit into a first gap, but does fit into a subsequent second gap. In this way, it is possible to ascertain a time for each of the N×N combinations, said time having to be awaited between a pulse Pᵢ and a pulse Pᵢ₊₁. FIGS. 7 and 8 indicate N×N combinations with a first receiver setting combination of blocks EE1, EE2 and EE2 in FIG. 7 and a second receiver setting combination of blocks EE1 and EE2 in FIG. 8.

Thus, given a sequence of channels, the subsequent channel of each channel is fitted in time in order to obtain a sequence that is as short as possible. This procedure can be performed for every possible sequence of individual pulses Pᵢ, wherein no new measurements are required and only the recorded echo sequences are considered. As a result, a full calculation of the overall time of all permutations can be performed. Since the last channel is directly followed by another measurement of the first channel, this pair must also be considered. After the calculation has been completed, a list (N−1)! of different overall cycle times emerges, it now being possible to sort said list in ascending order. This is represented by table 1:

TABLE 1

| Pulse sequence | |
|---|---|
| 10-8-4-3-1-2-9-12-11-5-7-6-10- . . . | 4.39 |
| 10-8-4-3-1-2-9-12-11-6-7-5-10- . . . | 4.86 |
| 10-4-3-1-9-2-8-12-11-6-7-5-10- . . . | 5.49 |
| . . . | |

Moreover, a check is carried out as to whether the influence of the penultimate pulse, antepenultimate pulse, etc., could lead to inadmissible late reverberations. To this end, the entire sequence can be considered initially as a whole. In the optimal case, no bothersome reverberations can be seen in any of the channels. The pulse sequence can be used in this way, with this being able to minimize the overall test time. With this, the algorithm is completed.

If late reverberations are visible in one receiver setting or in a plurality of receiver settings, then the preceding pulse that has caused the problem should be identified first. Subsequently, a latency between the two pulses should be lengthened accordingly. By way of example, considering the pulse sequence 10-8-4-3-1-2-9-12-11-5-7-6-10- . . . , if a late reverberation caused by pulse 5 is found in pulse 10, additional latencies can be inserted between pulses 5 and 7, 7 and 6 and/or 6 and 10 in a manner fitting to the gaps. Thereupon, a check should be carried out as to whether this was sufficient.

A new, slightly longer overall cycle time arises after the latencies were amended accordingly and all unwanted reverberations were removed. What may arise when this overall cycle time is compared with the overall cycle times of other pulse sequences is that the cycle becomes longer in comparison with other cycles. In this case, the longer cycle of the first pulse sequence can be accepted as sufficiently short in table 2, illustrated below. In some embodiments, a further optimization may be carried out, for example by testing the second pulse sequence in table 2 using the above-described methods.

TABLE 2

| Pulse sequence | |
|---|---|
| 10-8-4-3-1-2-9-12-11-5-7-6-10- . . . | adapted 4.89 |
| 10-8-4-3-1-2-9-12-11-6-7-5-10- . . . | 4.86 |
| 10-4-3-1-9-2-8-12-11-6-7-5-10- . . . | 5.49 |

For an N×N combinations matrix of pulses Pi and reception settings EEi, with i=1 . . . N, a time signal is recorded over a long time period, said long time period containing all subsequent echoes with a relevant aptitude. A specification is defined for the maximum permissible amplitude of phantom echoes and set as “block” or as reception setting EEi.

The latencies following the pulses and the minimum cycle duration are derived in each case from the matrix of N×N times signals and the amplitude specification for possible permutations of the pulses. The optimized or optimal pulse sequence is selected on the basis thereof.

Among others, the following variations may arise:

An automatic determination of the length of the recording time period, wherein a repetition with a longer recording time period may arise. By way of example, this may arise by virtue of a decaying exponential function being determined, the latter representing an envelope of the time signal and being checked. By way of example, a check can be carried out as to whether the envelope undershoots a certain value at the end of the recording time period, for example whether the smallest amplitude specification for phantom echoes is not too large.

The ascertained latencies following the pulses Pi are used directly for programming a test appliance or a test system. Known discrete optimization techniques can be used in place of the complete calculation for all channel permutations in the case of a large number of channels.

An exhaustive search for the shortest latency may require great computational outlay in the case of very complex systems because the number of permutations increases with the factorial of the channel number in this case. In this case, a Monte Carlo approach, for example, can be combined with the fully permutative approach. This can be implemented as follows:

Instead of calculating all permutations in full, a subset of the channels is randomly selected and this subset is completely permutated and optimized per se. Thereupon, the same procedure is carried out with the remaining channels in order subsequently to chain together all channels. This significantly reduces the computation time, and so a series of subset choices can be used. Instead of a subdivision into two subsets, a more compartmentalized division into three or more subsets is possible. The overall test duration is no longer optimal in this approach; however, it can approach an optimal test duration.

In the case of test objects with material properties that vary in a spatially dependent manner, or if the geometry of the test object changes along the scan path, this can be taken into account by virtue of the time signals for each of the N×N combinations of pulse and reception parameters being measured at a plurality of positions and the maximum of the time signals being subsequently determined over all positions; using this, the method according to the invention can be performed as described above.

Likewise, there can be an automatic reevaluation of the shortest pulse sequence at regular intervals, in parallel with a test, particularly in the case of test objects with material properties that vary in a spatially dependent manner.

Instead of determining all time signals for every one of the N×N combinations of pulse and reception parameters, only some of the signals can likewise be determined by means of measurement, the remainder being able to be replaced by prior knowledge or by means of further suitable assumptions.

For an FMC test, the plurality of reception settings can be approximated by means of a single reception setting. A possible procedure for finding a disturbing preceding impulse or preceding pulse can be the following:

By way of example, if a late reverberation can be found in the receiver setting 10 in the pulse sequence 10-8-4-3-1-2-9-12-11-5-7-6-10-000, the chain can be incrementally shortened or lengthened. Here, lengthening leads more directly to the result. The fact that the signal of late reverberations becomes ever weaker is known. That is to say, the chain 7-6-10 is tried first, followed by the chain 5-7-6-10 and the chain 11-5-7-6-10, and the pulse causing the problem is ascertained.

A further possible procedure for checking whether the adaptation of the pulse sequence was sufficient may lie in testing the partial chains and, subsequently, the entire inspection chain. Testing the partial chains can be implemented in such a way that the partial chain length is incrementally increased because the pulse would otherwise have to be displaced further.

Instead of the shortest pulse sequence of table 1, it is likewise possible to select a slightly longer pulse sequence if, as a result, the remaining signals lie further under the associated block and the signal-to-noise ratio is increased as a result thereof. At least in contrast to the prior art, the pulse repetition rate and the sequence of the channels are set by machine. An optimally short test duration is guaranteed in the case of an exhaustive search, while very much outlay and much experience are necessary to obtain comparable results when these are set manually.

The test duration can be effectively minimized. The test costs can be effectively reduced. There can be optimal use of the test equipment and the members of test staff. Defective tests that have to be corrected on account of phantom echoes can be avoided. In some embodiments, there can likewise be a test time optimization in the case of test objects with material properties that vary in a spatially dependent manner since a plurality of positions can be taken into account.

FIG. 9 shows an exemplary embodiment of a method incorporating the teachings herein. A computer device is used to ascertain shortest required respective latencies between two successive pulses for all possible firing sequences in a first step S1 and, subsequently, an optimized firing sequence of the shortest possible test cycle of the probes in a second step S2.

What is claimed is:

1. A method for ultrasonic testing with a selection of probes, the method comprising:
ascertaining a set of shortest required respective latencies between two successive pulses for all possible firing sequences;
calculating an optimized firing sequence of the shortest possible test cycle of the probes; and
controlling the probes based on the optimized firing sequence to conduct an ultrasonic test.

2. The method as claimed in claim 1, further comprising detecting a combination of N pulses Pi with N reception settings EEi wherein i=1 . . . N.

3. The method as claimed in claim 1, further comprising recording a time signal is recorded over a time period for an N×N combinations matrix of pulses Pi and reception settings EEi with i=1 . . . N, said time period containing all subsequent echoes with a relevant amplitude.

4. The method as claimed in claim 3, wherein a specification is predefined for a maximum admissible amplitude of phantom echoes and set as reception setting EEi.

5. The method as claimed in claim 4, further comprising deriving latencies following the pulses Pi and a minimum cycle duration based at least in part on a matrix of N×N time signals and the amplitude specification for possible permutations of the pulses.

6. The method as claimed in claim 5, further comprising selecting an optimized pulse sequence.

7. The method as claimed in claim 3, further comprising:
determining a length of the recording time period, wherein a decaying exponential function represents an envelope of a time signal being determined; and
checking whether the envelope at the end of the recording time period undershoots a certain value.

8. The method as claimed in claim 1, further comprising using the ascertained latencies following the pulses Pi directly for programming a test appliance or a test system.

9. The method as claimed in claim 1, wherein discrete optimization techniques are used in place of full calculation for all channel permutations.

10. The method as claimed in claim 1, further comprising combining a Monte Carlo approach with a fully permutative approach.

11. The method as claimed in claim 1, further comprising measuring time signals for each of N×N combinations of pulse parameters and reception parameters at a plurality of positions; and
determining a maximum of the time signals over all positions.

12. The method as claimed in claim 1, further comprising reevaluating the shortest pulse sequence at regular intervals, in parallel with a test.

13. The method as claimed in claim 1, further comprising, instead of determining all time signals for every one of N×N combinations of pulse and reception parameters, only some of the signals are determined by means of measurement, and the remainder are replaced by prior knowledge.

14. The method as claimed in claim 1, further comprising approximating a plurality of reception settings by means of a single reception setting for an FMC test.

15. An apparatus for ultrasonic testing, the apparatus comprising:
a plurality of ultrasonic probes; and
a computer having a processor in communication with a memory;
the memory storing a set of instructions, the set of instructions, when executed by the processor, causing the processor to:
ascertaining a set of shortest required respective latencies between two successive pulses for all possible firing sequences of the plurality of probes;
calculating an optimized firing sequence of the shortest possible test cycle of the plurality of probes; and
controlling the plurality of probes based on the optimized firing sequence to conduct an ultrasonic test.
